(19) United States
(12) Patent Application Publication
(10) Pub. No.: US 2007/0245051 A1
(43) Pub. Date: Oct. 18, 2007

(54) SYSTEM AND METHOD FOR BANDWIDTH SHARING IN BUSSES

(75) Inventor: Jing Jung HUANG, Taipei City (TW)

Correspondence Address: LOWE HAUPTMAN HAM & BERNER, LLP, 1700 DIAGONAL ROAD, SUITE 300, ALEXANDRIA, VA, 22314, US

(73) Assignee: REALTEK SEMICONDUCTOR CORP., Hsinchu (TW)

(21) Appl. No.: 11/735,960

(22) Filed: Apr. 16, 2007

(30) Foreign Application Priority Data
Apr. 17, 2006 (TW) 095113609

(51) Int. Cl. G06F 13/36

(52) U.S. Cl. 710/113

(57) ABSTRACT

A system for bandwidth sharing in busses comprises a priority-based shared bus, a timer for counting a predetermined period of time, and a plurality of masters using the shared bus to transmit data, wherein one of the masters has the highest priority to use the shared bus and can only send a predetermined number of bus request signals within the predetermined period of time for requesting the right for using the shared bus to transmit data. The present invention also provides a method for bandwidth sharing in busses.

### CROSS REFERENCE TO RELATED APPLICATION

This application claims the priority benefit of Taiwan Patent Application Serial Number 095113609, filed on Apr. 17, 2006, the full disclosure of which is incorporated herein by reference.

### BACKGROUND OF THE INVENTION

1. Field of the Invention

This invention generally relates to a system and a method for bandwidth sharing, and more particularly to a system and a method for bandwidth sharing in priority-based shared busses.

2. Description of the Related Art

FIG. 1 shows a circuit block diagram of a conventional system 10 for bandwidth sharing in a priority-based shared bus. The system 10 includes a central processing unit (CPU) 12, a memory unit 14, a plurality of masters 16a, 16b, 16c, a shared bus 18, and a bus arbiter 20. The central processing unit 12, the memory unit 14 and the plurality of masters 16a, 16b, 16c are connected to the shared bus 18 for data transmission through the shared bus 18. In addition, the bus arbiter 20 is for arbitrating the right for accessing the shared bus 18 among the plurality of masters 16a, 16b, 16c.

In the system 10, the masters 16a, 16b, 16c represent units having the ability to access memories or peripheral devices. The masters 16a, 16b, 16c can be control circuits of peripheral devices such as DVD players, monitors, printers, hard disks, network devices, with at least one direct memory access (DMA) control circuit (not shown) for controlling data transmission with other units, like the memory unit 14 or within the masters 16a, 16b, 16c.

The masters 16a, 16b, 16c have different priorities to claim the right for use of the shared bus 18, where in general, a master having real-time processing needs e.g. the control unit of a monitor or a DVD player, is usually given a higher priority, while a master having no real-time processing needs e.g. a master of a hard disk, is usually given a lower priority.

In the system 10, it is assumed that the master 16a possesses the highest priority while the masters 16b, 16c possess lower priorities. When the masters 16a, 16b, 16c are competing for the shared bus 18 simultaneously, bus request signals REQ1, REQ2 and REQ3 are sent to the bus arbiter 20 respectively through their DMA control circuits. The bus arbiter 20 receives the bus request signals REQ1, REQ2 and REQ3 and sends a bus grant signal GNT according to the priority levels of the masters 16a, 16b, 16c, such that the master 16a having the highest priority receives the grant for prior use of the shared bus 18 for data transmission.

In the following conditions, the master 16a having the highest priority may send the bus request signals REQ1 constantly.

1. At the beginning of a reading operation:

When a data buffer located in the master 16a reads from the shared bus 18 and transmits data to a peripheral device, constant request signals REQ1 at the beginning of a reading operation could be sent through the shared bus 18, e.g. the bus request signals REQ1 sent at time t0, t1 and t2 as shown in FIG. 2a. In such cases, a predetermined amount of data from the shared bus 18 is stored in the data buffer rapidly. FIG. 2a shows the bus request signals REQ1 sent by the master 16a during a reading operation wherein the time interval T1 between time t0 and t1 and between time t1 and t2 is shorter than the time interval T2 between time t2 and t3 and between time t3 and t4.

2. At the end of a writing operation:

When the data sent out by a peripheral device is to be written to the shared bus 18 through a data buffer located in the master 16a, the bus request signals REQ1 are constantly sent at the end of this writing operation, e.g. the bus request signals REQ1 sent at time t3 and t4 as shown in FIG. 2b. In such cases, the last data stored within the data buffer will be written to the shared bus 18 rapidly. FIG. 2b shows the bus request signals REQ1 sent by the master 16a during a writing operation wherein the time interval T1 between time t3 and t4 is shorter than the time interval T2 between time t1 and t2 and between time t2 and t3.

3. During a reading operation or a writing operation:

When the master 16a reads or writes data to the shared bus 18 without speed limitations, the bus request signals REQ1 will be constantly sent using its highest speed during a reading operation or a writing operation, e.g. the bus request signals REQ1 sent at time t1, t2, t3 and t4 as shown in FIG. 2c. FIG. 2c shows the bus request signals REQ1 sent by the master 16a during a reading operation or a writing operation, wherein the master 16a sends the bus request signals REQ1 from time t1 to t4 constantly, and the time interval between each consecutive bus request signals REQ1 is T1.

In the three conditions aforementioned, the master 16a having the highest priority occupies the shared bus 18 by sending the bus request signals REQ1 constantly, whereas other masters 16b, 16c having lower priorities will not be able to use the shared bus 18 in a timely manner to transmit data, causing improper operations or even system crashes.

### SUMMARY OF THE INVENTION

It is an object of the present invention to provide a system and a method for bandwidth sharing in busses, which can solve the above problems in the prior art without increasing additional memories or bandwidths.

In order to achieve the above object, the present invention provides a system for bandwidth sharing in busses, which comprises a priority-based shared bus, a timer for counting a predetermined period of time, and a plurality of masters using the shared bus to transmit data, wherein one of the masters has the highest priority to use the shared bus and can only send a predetermined number of bus request signals within the predetermined period of time for requesting the right for using the shared bus to transmit data.

The present invention also provides a method for bandwidth sharing in busses, which comprises: counting a predetermined period of time; utilizing a master to send a predetermined number of bus request signals during the predetermined period of time for requesting to use a shared bus; and utilizing a bus arbiter to send at least one bus grant signal for responding to the bus request signals.

The present invention also provides a method for bandwidth sharing in busses, which comprises: counting a predetermined period of time; utilizing a master to send a plurality of bus request signals for requesting to use the shared bus; and utilizing a bus arbiter to send a predetermined number of bus grant signals during the predetermined period of time for responding to the bus request signals.

According to one embodiment of the present invention, a time interval between two consecutive bus request signals sent by a master is equal to or larger than the predetermined period of time.

According to another embodiment of the present invention, a time interval between two consecutive bus grant signals sent by a arbiter is equal to or larger than the predetermined period of time.

### BRIEF DESCRIPTION OF THE DRAWINGS

Other objects, advantages, and novel features of the present invention will become more apparent from the following detailed description when taken in conjunction with the accompanying drawings.

FIG. 1 shows a circuit block diagram of a conventional system for bandwidth sharing in a priority-based shared bus.

FIG. 2a shows the bus request signals REQ1 sent by a master shown in FIG. 1 during a reading operation.

FIG. 2b shows the bus request signals REQ1 sent by a master shown in FIG. 1 during a writing operation.

FIG. 2c shows the bus request signals REQ1 sent by a master shown in FIG. 1 during a reading operation or a writing operation.

FIG. 3 shows a circuit block diagram of a system for bandwidth sharing in a shared bus according to one embodiment of the present invention.

FIGS. 4a and 4b show a schematic view of a data buffer for illustrating the operation of the master shown in FIG. 3 during a reading operation.

FIG. 5 shows the bus request signals REQ1 sent by a master shown in FIG. 3 during a reading operation.

FIGS. 6a, 6b and 6c show a schematic view of a data buffer for illustrating the operation of the master shown in FIG. 3 during a writing operation.

FIG. 7 shows the bus request signals REQ1 sent by a master shown in FIG. 3 during a writing operation.

FIG. 8 shows the bus request signals REQ1 sent by a master shown in FIG. 3 during a reading operation or a writing operation.

FIG. 9 shows a circuit block diagram of a system for bandwidth sharing in a shared bus according to one alternative embodiment of the present invention.

FIG. 10 shows a circuit block diagram of a system for bandwidth sharing in a shared bus according to another embodiment of the present invention.

FIG. 11 shows the bus request signals REQ1 sent by a master shown in FIG. 10 during a predetermined period of time T.

FIG. 12 shows a circuit block diagram of a system for bandwidth sharing in a shared bus according to another alternative embodiment of the present invention.

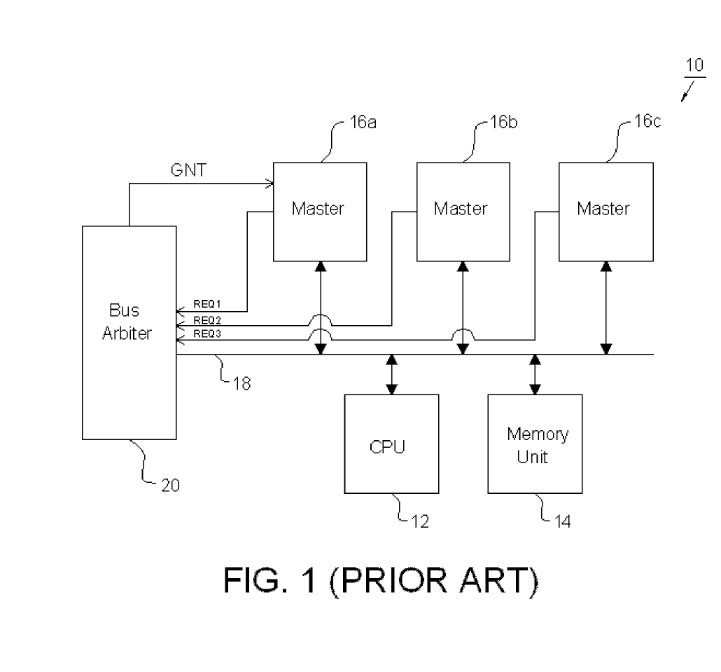

### DETAILED DESCRIPTION OF THE PREFERRED EMBODIMENT

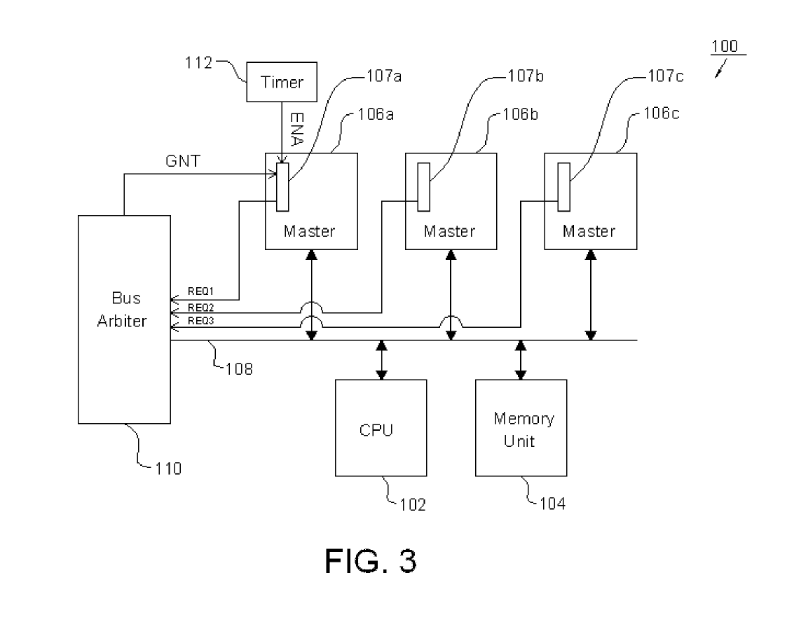

FIG. 3 shows a circuit block diagram of a system 100 for bandwidth sharing in busses according to one embodiment of the present invention. The system 100 can be implemented in a system on chip (SOC) and includes a central processing unit (CPU) 102, a memory unit 104, a plurality of masters 106a, 106b, 106c, a shared bus 108, a bus arbiter 110 and a timer 112. The central processing unit 102, the memory unit 104 and the masters 106a, 106b, 106c transmit data through the shared bus 108. The shared bus 108 is priority-based, and the masters 106a, 106b, 106c have different priorities regarding the use of the shared bus 108. The bus arbiter 110 is for arbitrating the right for accessing the shared bus 108 among the masters 106a, 106b, 106c according to the ranking of the priorities. The timer 112 is for counting a predetermined period of time T, and sends an enabling signal ENA to the master 106a after finishing counting the predetermined period of time T. The predetermined period of time T can be the time that the timer 112 spends for counting upward (or downward) from an initial value, e.g. 0 (or 99) to a predetermined value, e.g. 99 (or 0).

In this embodiment, the masters 106a, 106b, 106c represent units having the ability to access memory or peripheral devices. In addition, each of the masters 106a, 106b, 106c can be any control circuit in peripheral devices such as DVD players, monitors, printers, hard disks, network devices and so on, and possesses a direct memory access (DMA) controller 107a, 107b, 107c, respectively, for controlling data transmission with other units, which are connected to the shared bus 108.

In the system 100, the master 106a owns the highest priority for using the shared bus 108 while the masters 106b, 106c own lower priorities for using the same. When the masters 106a, 106b, 106c are in need of the shared bus 108 at the same time, bus request signals REQ1, REQ2 and REQ3 are sent respectively to the bus arbiter 110 through their DMA controllers 107a, 107b, 107c. The bus arbiter 110 receives the bus request signals REQ1, REQ2 and REQ3 and grants the right of using the shared bus 108 to the master having the highest priority according to the ranking of the priorities of the masters 106a, 106b, 106c. After receiving the bus request signals REQ1, REQ2 and REQ3, the bus arbiter 110 sends a bus grant signal GNT to the DMA controller 107a to respond to the bus request signal REQ1 whereby granting the master 106a to use the shared bus 108 first to transmit data. When the master 106a ends the session of using the shared bus 108, the bus arbiter 110 then sends other bus grant signals GNT to respond to the bus request signals REQ2 and REQ3 whereby granting the masters 106b, 106c, which have lower priorities, to use the shared bus 108 to transmit data.

In the embodiment of the present invention, the timer 112 begins to count the predetermined period of time T after the master 106a sends a bus request signal REQ1. After the timer 112 finishes counting the predetermined period of time T, it sends an enabling signal ENA to the master 106a for enabling the master 106a to send the next bus request signal REQ1. In this embodiment, the master 106a will wait until the timer 112 finishes counting the predetermined period of time T and that the enabling signal ENA is received before sending the next bus request signal REQ1 to the bus arbiter 110. Therefore, the time interval between two consecutive bus request signals REQ1 sent by the master 106a can be limited and not be too close. In addition, when the bus arbiter 110 receives a bus request signal REQ1, it sends a corresponding bus grant signal GNT to respond to the received bus request signal REQ1 whereby granting the master 106a to use the shared bus 108 to transmit data.

In the system 100, the predetermined period of time T, for which the timer 112 counts, needs to be long enough such that other masters 106b, 106c with lower priorities can use the shared bus 108 to transmit data during the period between two consecutive bus request signals REQ1 sent by the master 106a, whereby preventing the problems of improper operations and crashes. The following will provide three examples for illustrating the system 100 in different applications.

1. At the beginning of a reading operation:

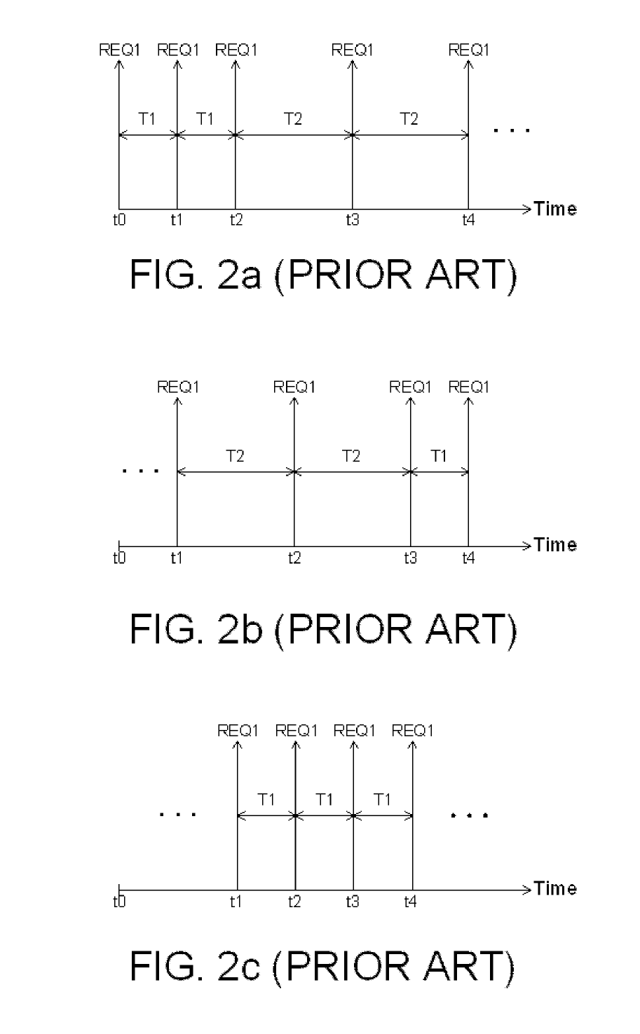

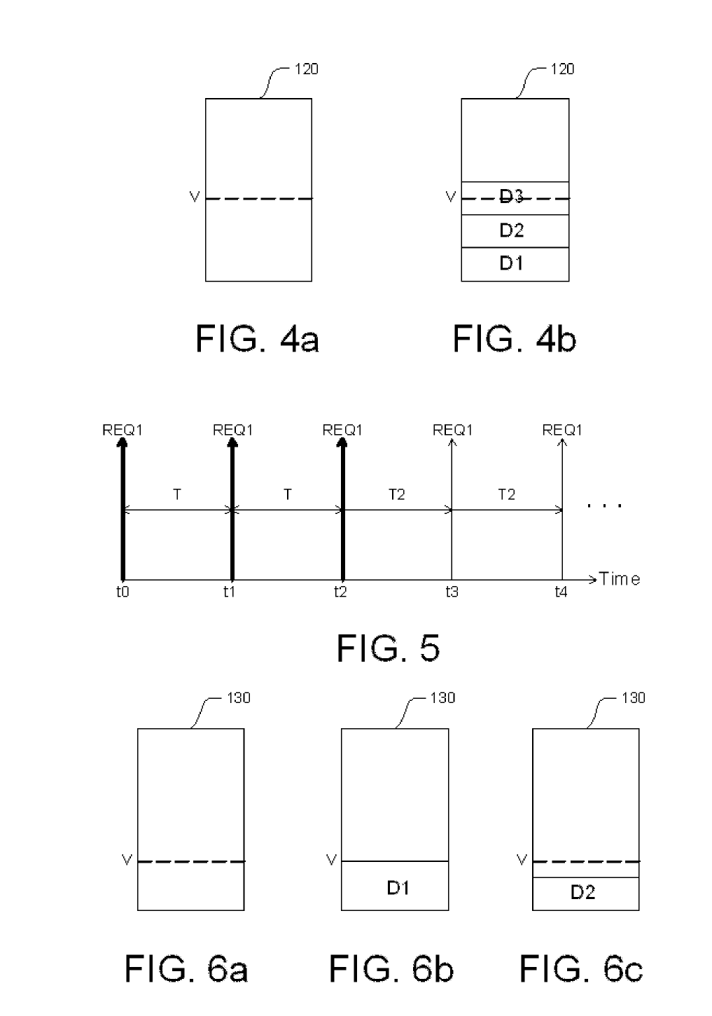

When a data buffer 120 (as shown in FIG. 4a) located in the master 106a reads from the shared bus 108 and transmits data to a peripheral device, bus request signals REQ1 are sent when the data temporarily stored in the data buffer 120 is less than a predetermined amount V (illustrated in FIG. 4a as a broken line). The master 106a will be able to limit the time interval between two consecutive bus request signals REQ1 by using the timer 112 at the beginning of a reading operation whereby solving the problems caused by the tight schedule of bus request signals REQ1 as shown in FIG. 2a.

FIG. 5 shows the bus request signals REQ1 sent by the master 106a during a reading operation. At the beginning of a reading operation, since no data is stored in the data buffer 120 (as shown in FIG. 4a), apparently meaning that data stored in the data buffer 120 is less than the predetermined amount V, the master 106a sends the bus request signals REQ1 respectively at time t0, t1 and t2 whereby reading data D1, D2 and D3 from the shared bus 108 to the data buffer 120. As shown in FIG. 4b, the total amount of data D1, D2 and D3 is larger than the predetermined amount V. In this embodiment, after sending a bus request signal REQ1 at time t0, the next bus request signal REQ1 will be sent at time t1, which is until the timer 112 finishes counting the predetermined period of time T and the master 106a receives the enabling signal ENA. The timer 112 needs to re-count the predetermined period of time T such that the master 106a will send the next bus request signal REQ1 at time t2. When the data stored in the data buffer 120 is larger than the predetermined amount V (as shown in FIG. 4b), the master 106a will send the bus request signal REQ1 to the bus arbiter 110 only after a period of time T2.

2. At the end of a writing operation:

When the data sent out by a peripheral device is to be written to the shared bus 108 through a data buffer 130 (as shown in FIG. 6a) located in the master 106a, bus request signals REQ1 are sent when the data stored in the data buffer 130 is equal to or larger than a predetermined amount V (illustrated in FIG. 6a as a broken line). When the stored data is the last data, the time interval between two consecutive bus request signals REQ1 is limited by the counting of the timer 112 at the end of a writing operation whereby solving the problems caused by the tight schedule of bus request signals REQ1 as shown in FIG. 2b.

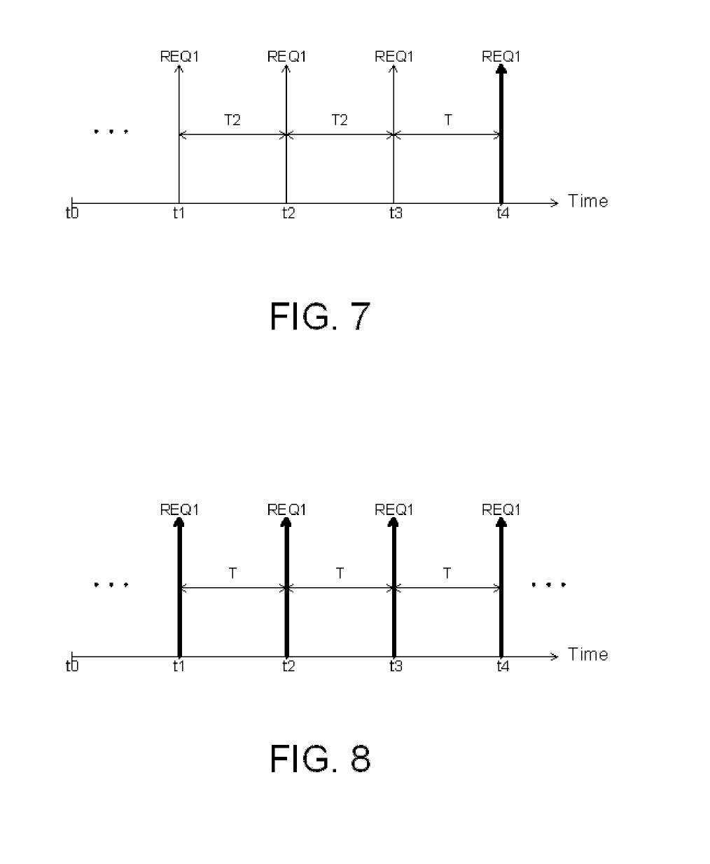

FIG. 7 shows the bus request signals REQ1 sent by the master 106a during a writing operation. During a writing operation (i.e. time t0 to t4), each time when the data buffer 130 receives data D1 (as shown in FIG. 6b) with a data amount of V from a peripheral device, the master 106a sends the bus request signals REQ1, respectively at time t1, t2 and t3 (as shown in FIG. 7), in order to write the data D1 stored in the data buffer 130 to the shared bus 108. At the end of the writing operation, if the last data stored in the data buffer 130 is D2 with a data amount which may be less than the predetermined amount V (as shown in FIG. 6c), then the time for the data buffer 130 to receive the data D2 from the peripheral device may be shorter than the time required to receive the data D1. In this embodiment, the master 106a will not send the bus request signal REQ1 when the data buffer 130 receives the last data D2, the bus request signal REQ1 will be sent at time t4 for writing the last data D2 to the shared bus 108 when the timer 112 finishes counting the predetermined period of time T and the master 106a receives the enabling signal ENA.

3. During a reading operation or a writing operation:

When the master 106a constantly sends bus request signals REQ1 during a reading operation or a writing operation, the time interval between two consecutive bus request signals REQ1 is limited by the counting of the timer 112 during the reading operation or the writing operation whereby solving the problems caused by the tight schedule of the bus request signals REQ1 as shown in FIG. 2c.

FIG. 8 shows the bus request signals REQ1 sent by the master 106a during a reading operation or a writing operation. During the reading or writing operation, the master 106a sends a bus request signal REQ1, e.g. the bus request signal REQ1 sent at time t1, t2, t3 and t4 as shown in FIG. 8. The bus arbiter 110 sends a bus grant signal GNT for granting the master 106a the right to transmit data using the shared bus 108. The timer 112 then begins to count a predetermined period of time T while the master 106a will wait until the enabling signal ENA is received after the timer 112 finishes counting the predetermined period of time T and sends the next bus request signal REQ1.

In FIG. 5, FIG. 7, and FIG. 8, the predetermined period of time T and the period of time T2 are long enough such that other masters 106b, 106c with lower priorities will be able to use the shared bus 108 to transmit data during the period between two consecutive bus request signals REQ1 sent by the master 106a, whereby preventing the problems of improper operations and crashes.

In the system 100 of the present invention, the time interval between two consecutive bus request signals REQ1 sent by the master 106a is equal to or longer than the predetermined period of time T, therefore, the master 106a will not constantly occupy the shared bus 108 whereby preventing the masters 106b, 106c with lower priorities from improper operations and crashes.

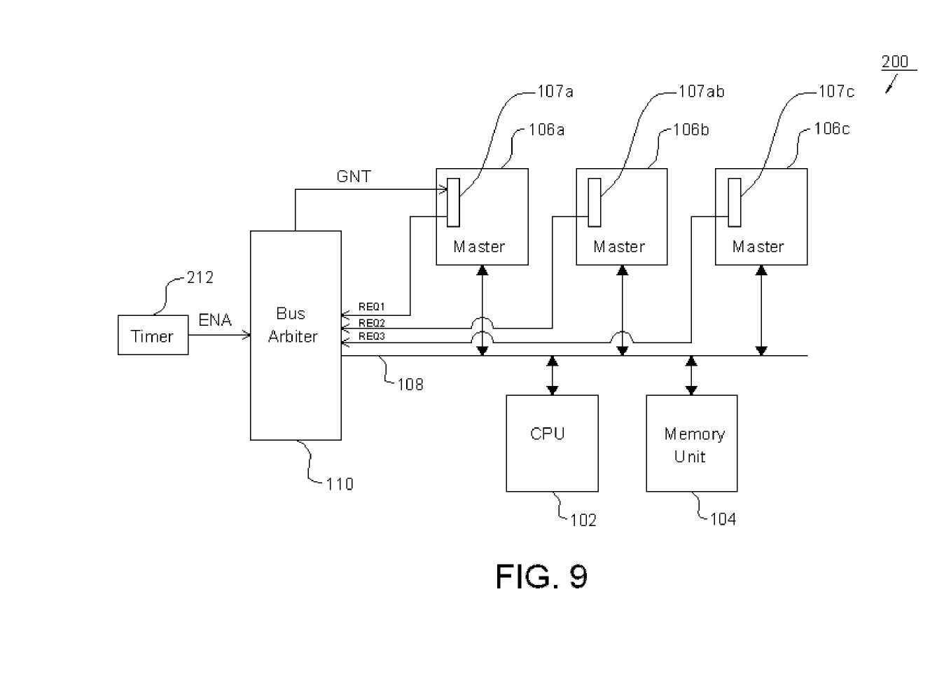

FIG. 9 shows a circuit block diagram of a system 200 for bandwidth sharing in busses according to one alternative embodiment of the present invention. In FIG. 9, the elements, which are identical to those shown in FIG. 3, are indicated by the same numerals and will not be described herein. The bus arbiter 110 can limit the time interval between two consecutive bus grant signals GNT, which are to be sent to the master 106a, by the counting of a timer 212. In the system 200 of the present invention, a time interval between two consecutive bus grant signals GNT sent by the bus arbiter 110 is equal to or larger than the predetermined period of time T. Therefore, the master 106a will not possess the right for using the shared bus 108 continuously whereby preventing the masters 106b, 106c from improper operations and crashes.

According to the systems 100 and 200 in the above-mentioned embodiments of the present invention, a time interval between two consecutive bus request signals REQ1 sent by the master 106a or between two consecutive bus grant signals GNT sent by the bus arbiter 110 is limited. Therefore, the master 106a will not be using the shared bus 108 continuously such that the masters 106b, 106c with lower priorities can timely use the shared bus 108 to transmit data.

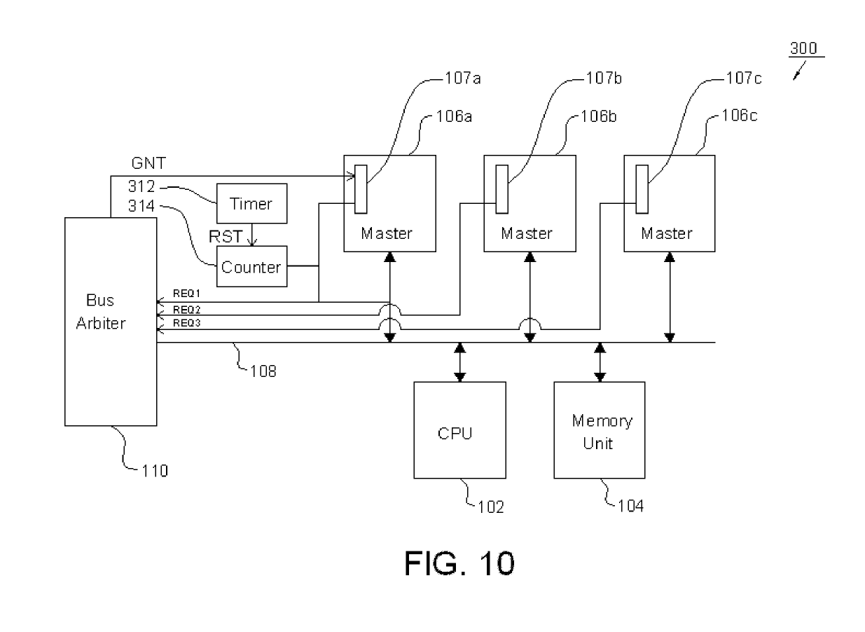

FIG. 10 shows a circuit block diagram of a system 300 for bandwidth sharing in busses according to another embodiment of the present invention. The system 300 can be implemented in a system on chip. In FIG. 10, the elements, which are identical to those shown in FIG. 3, are indicated by the same numerals and will not be described herein. The system 300 includes a timer 312 and a counter 314. The timer 312 is for counting a predetermined period of time T, and is able to send a reset signal RST to the counter 314 after finishing the counting and then undergoes a re-count. The counter 314 is for counting the number of the bus request signals REQ1 sent by the master 106a during the predetermined period of time T and then re-counting it after receiving the reset signal RST.

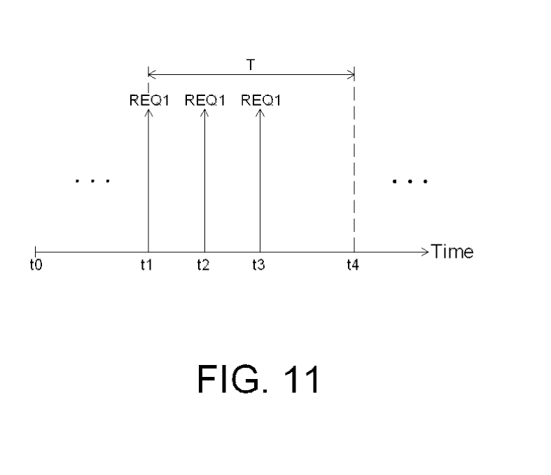

Now referring to FIG. 10 and FIG. 11, when the timer 312 counts the predetermined period of time T (e.g. time t1 to t4), the counter 314 counts the number of the bus request signals REQ1 sent by the master 106a. In the system 300 of the present invention, when the counter 314 counts to a predetermined number of bus request signals REQ1, e.g. three bus request signals REQ1 at time t1, t2 and t3 as shown in FIG. 11, within the predetermined period of time T, the bus arbiter 110 may adjust the priority of the master 106a to be lower than the priorities of the masters 106b, 106c. Therefore, the masters 106b, 106c can possess the right for using the shared bus 108 during time t3 to t4, which is after the time when the master 106a sends three bus request signals REQ1 to the bus arbiter 110. When the timer 312 finishes counting the predetermined period of time T, it begins to re-count the next predetermined period of time T and sends the reset signal RST to the counter 314 such that the counter 314 can also begin to re-count the number of the bus request signals REQ1 sent by the master 106a during the next predetermined period of time T. Further, when the timer 312 finishes counting the predetermined period of time T, the arbiter 110 may adjust the priority of the master 106a back to the highest such that the master 106a can have the right for using the shared bus 108 to transmit data first.

In this embodiment, the master 106a can only send a predetermined number of bus request signals REQ1, e.g. three bus request signals REQ1, during the predetermined period of time T, such that the number of the bus request signals REQ1 sent by the master 106a can be limited. Therefore, the master 106a will no longer occupy the shared bus 108 constantly, preventing the masters 106b, 106c with lower priorities from having the problems of improper operations and crashes.

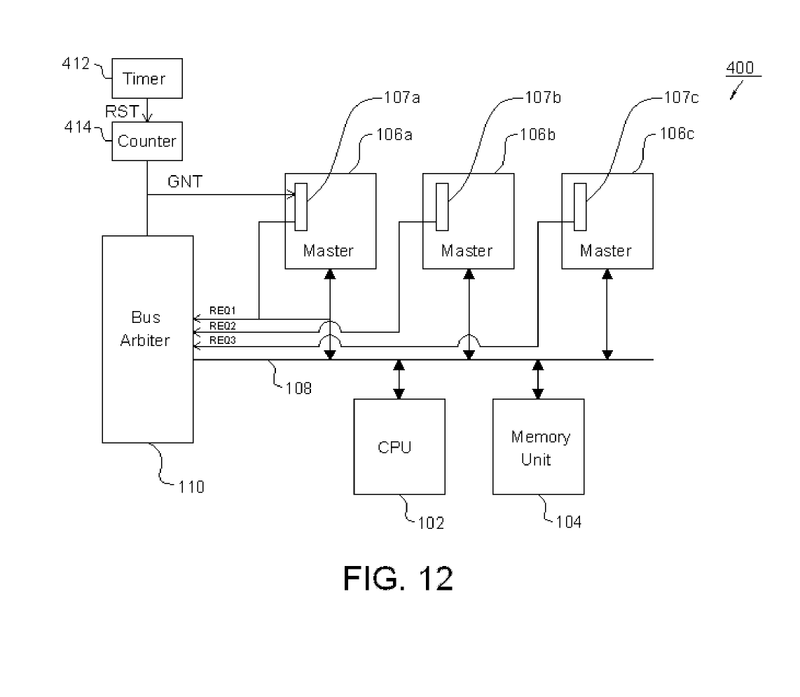

FIG. 12 shows a circuit block diagram of a system 400 for bandwidth sharing in busses according to another alternative embodiment of the present invention. In FIG. 12, the elements which are identical to those shown in FIG. 10 are indicated by the same numerals and will not be described herein. The main difference between the system 400 and the system 300 shown in FIG. 10 is that the system 400 includes a timer 412 and a counter 414. The timer 412 is for counting a predetermined period of time T, and will send a reset signal RST to the counter 414 after finishing the counting and then will start a re-count of the predetermined period of time T. The counter 414 is for counting the number of the bus grant signals GNT sent by the bus arbiter 110 to the master 106a during the predetermined period of time T and then re-counting after receiving the reset signal RST.

In the system 400, the timer 412 and the counter 414 are for limiting the number of the bus grant signals GNT sent by the arbiter 110 to the master 106a during the predetermined period of time T, and their operations are similar to the operations of the timer 312 and the counter 314, which are for limiting the number of the bus request signals REQ1 sent by the master 106a, and thus will not be described in detail. In this embodiment, the arbiter 110 can only send a predetermined number of bus grant signals GNT to the master 106a during a predetermined period of time T. Therefore, the master 106a will no longer occupy the shared bus 108 constantly, whereby preventing the masters 106b, 106c with lower priorities from having the problems of improper operations and crashes.

According to the systems 300 and 400 in the above-mentioned embodiments of the present invention, the number of the consecutive bus request signals REQ1 sent by the master 106a or the number of the consecutive bus grant signals GNT sent by the bus arbiter 110 is limited within a predetermined period of time; therefore, the master 106a will no longer be able to occupy the shared bus 108 over a long span of time such that the masters 106b, 106c with lower priorities can still use the shared bus 108 timely to transmit data, thus solving problems such as improper operations and crashes.

It should be noted that the system for bandwidth sharing in busses according to the present invention can limit the time interval between two consecutive bus request signals or bus grant signals, or in another embodiment, limit the number of the bus request signals or the bus grant signals during a predetermined period of time, without increasing additional memories or bandwidths.

Although the invention has been explained in relation to its preferred embodiment, it is not adapted to limit the invention. It is to be understood that many other possible modifications and variations can be made by those skilled in the art without departing from the spirit and scope of the invention as hereinafter claimed.

What is claimed is:

1. A system for bandwidth sharing in busses, comprising:
a shared bus;
a timer for counting a predetermined period of time; and
a plurality of masters using the shared bus to transmit data;
wherein one of the masters sends a predetermined number of bus request signals during the predetermined period of time whereby requesting the right for using the shared bus to transmit data.

2. The system as claimed in claim 1, further comprising a bus arbiter which sends at least one bus grant signal for responding to the bus request signals whereby granting the one of the masters to use the shared bus.

3. The system as claimed in claim 2, wherein the predetermined period of time is a time interval between two consecutive bus grant signals sent by the bus arbiter.

4. The system as claimed in claim 2, wherein the one of the masters comprises a direct memory access circuit for generating the bus request signals and for receiving the bus grant signal.

5. The system as claimed in claim 2, wherein the one of the masters comprises a buffer for temporarily storing a predetermined amount of data.

6. The system as claimed in claim 5, wherein when data stored in the buffer is less than the predetermined amount of data and when the timer finishes counting the predetermined period of time, the one of the masters generates the bus request signals.

7. The system as claimed in claim 5, wherein when data stored in the buffer is larger than the predetermined amount of data and when the timer finishes counting the predetermined period of time, the one of the masters generates the bus request signals.

8. The system as claimed in claim 1, wherein the predetermined number is one.

9. The system as claimed in claim 8, wherein a time interval between two consecutive bus request signals sent by the one of the masters is equal to or larger than the predetermined period of time.

10. The system as claimed in claim 8, wherein a time interval between two consecutive bus grant signals sent by the bus arbiter is equal to or larger than the predetermined period of time.

11. The system as claimed in claim 1, wherein the predetermined period of time is a time interval between two consecutive bus request signals sent by the one of the masters.

12. The system as claimed in claim 1, wherein the one of the masters has the highest priority for using the shared bus.

13. The system as claimed in claim 1, wherein the one of the masters comprises a buffer for temporarily storing a predetermined amount of data.

14. The system as claimed in claim 1, which is implemented in a system on chip.

15. A method for bandwidth sharing in busses, comprising:
counting a predetermined period of time;
utilizing a master to send a predetermined number of bus request signals during the predetermined period of time for requesting to use a shared bus; and
utilizing a bus arbiter to send at least one bus grant signal for responding to the bus request signals.

16. The method as claimed in claim 15, wherein the predetermined number is one.

17. The method as claimed in claim 16, wherein a time interval between two consecutive bus request signals sent by the master is equal to or larger than the predetermined period of time.

18. The method as claimed in claim 16, wherein a time interval between two consecutive bus grant signals sent by the bus arbiter is equal to or larger than the predetermined period of time.

19. The method as claimed in claim 15, wherein the predetermined period of time is a time interval between two consecutive bus request signals sent by the master.

20. The method as claimed in claim 15, wherein the predetermined period of time is a time interval between two consecutive bus grant signals sent by the bus arbiter.

21. The method as claimed in claim 15, wherein the shared bus is a priority-based shared bus.

22. The method as claimed in claim 15, wherein the master has the highest priority for using the shared bus.

23. The method as claimed in claim 15, which is implemented in a system on chip.

24. A method for bandwidth sharing in busses, comprising:
counting a predetermined period of time;
utilizing a master to send a plurality of bus request signals for requesting to use a shared bus; and
utilizing a bus arbiter to send a predetermined number of bus grant signals during the predetermined period of time for responding to the bus request signals.

25. The method as claimed in claim 24, wherein the predetermined number is one.

26. The method as claimed in claim 25, wherein a time interval between two consecutive bus request signals sent by the master is equal to or larger than the predetermined period of time.

27. The method as claimed in claim 25, wherein a time interval between two consecutive bus grant signals sent by the bus arbiter is equal to or larger than the predetermined period of time.

28. The method as claimed in claim 24, wherein the predetermined period of time is a time interval between two consecutive bus request signals sent by the master.

29. The method as claimed in claim 24, wherein the predetermined period of time is a time interval between two consecutive bus grant signals sent by the bus arbiter.

30. The method as claimed in claim 24, wherein the shared bus is a priority-based shared bus.

31. The method as claimed in claim 24, wherein the master has the highest priority for using the shared bus.

32. The method as claimed in claim 24, which is applied to a system on chip.
